(19) United States
(12) Patent Application Publication
(10) Pub. No.: US 2025/0390145 A1
(43) Pub. Date: Dec. 25, 2025

(54) DISPLAY DEVICE AND ELECTRONIC DEVICE INCLUDING THE SAME

(71) Applicants: Samsung Display Co., LTD., Yongin-si (KR); Lotte Energy Materials Corporation, Iksan-si (KR)

(72) Inventors: NAMHEE PARK, Yongin-si (KR); SangYoon KIM, Iksan-si (KR)

(21) Appl. No.: 19/171,586

(22) Filed: Apr. 7, 2025

(30) Foreign Application Priority Data
Jun. 21, 2024 (KR) 10-2024-0080726

(51) Int. Cl. G06F 1/16

(52) U.S. Cl. CPC G06F 1/1656; G06F 1/1616

(57) ABSTRACT

A display device includes a display panel, a window disposed on a side of the display panel, and a cushion member disposed on a rear surface of the display panel, where the cushion member includes a high-density layer and a buffer layer on the high-density layer, and a low-density layer disposed on the buffer layer, where the low-density layer is disposed closer to the display panel than to the high-density layer.

This application claims priority to Korean Patent Application No. 10-2024-0080726, filed on Jun. 21, 2024, and all the benefits accruing therefrom under 35 U.S.C. § 119, the content of which in its entirety is herein incorporated by reference.

### BACKGROUND

### (a) Field

This disclosure relates to a display device.

### (b) Description of the Related Art

Electronic devices such as smartphones, mobile phones, tablets, multimedia players, televisions, and monitors include display devices for displaying images. The display device includes a display panel that implements a screen that displays an image. Flexible display devices capable of deformation such as bending, folding, rolling, and stretching are being developed using flexible substrates as display panel substrates. Among flexible display devices, foldable display devices may be folded and unfolded like a book.

### SUMMARY

Embodiments are intended to provide a display device that includes a cushion member that is excellent in absorbing and dispersing external shock and has excellent resilience.

The display device in an embodiment of the disclosure includes a display panel, a window disposed on one side of the display panel, and a cushion member disposed on a rear surface of the display panel, where the cushion member includes a high-density layer and a layer on the high-density layer, and a low-density layer disposed on the buffer layer, where the low-density layer is disposed closer to the display panel than the high-density layer.

In an embodiment, the high-density layer includes first hollow particles, the low-density layer includes second hollow particles, and the hollow volume of the high-density layer may be smaller than the hollow volume of the low-density layer.

In an embodiment, a size of a first hollow particle of the first hollow particles may be smaller than a size of a second hollow particle of the second hollow particles.

In an embodiment, the average diameter of the first hollow particles and the second hollow particles may be about 5 micrometers or more and about 120 micrometers or less.

In an embodiment, the weight ratio of the first hollow particles to the total weight in the high-density layer may be 0.5% by weight or more and 30% by weight or less.

In an embodiment, the density of the high-density layer is about 0.4 gram per cubic centimeter (g/cm³) or more, the density of the low-density layer is 0.5 g/cm³ or less, and the density of the low-density layer may be lower than the density of the high-density layer.

In an embodiment, each of the high-density layer and the low-density layer may include an adhesive polymer resin.

In an embodiment, the glass transition temperature of the adhesive polymer resin may be −70 degrees Celsius (° C.) to 0° C.

In an embodiment, the buffer layer may include at least one of thermoplastic polyurethane (“TPU”), polyurethane (“PU”), rubber, and olefin-based polymer.

In an embodiment, the cushion member may further include an additional buffer layer disposed on at least one of an upper surface of the low-density layer and a lower surface of the high-density layer.

In an embodiment, the display device may be folded out.

In an embodiment, the display device may further include a protective layer disposed on the display panel.

In an embodiment, the display device may further include a support member disposed on a rear surface of the display panel.

In an embodiment, the support member may include at least one of carbon fiber-reinforced plastic (“CFRP”), glass fiber-reinforced plastic (“GFRP”), stainless steel (“SUS”), aluminum (Al), magnesium (Mg), and titanium (Ti).

The display device in an embodiment of the disclosure includes a display panel, a window disposed on a first face of the display panel, and a cushion member disposed on a back face of the display panel, where the cushion member includes a high-density layer comprising first hollow particles, a buffer layer on the high-density layer and a low-density layer disposed on the buffer layer and including second hollow particles, where a density of the low-density layer is lower than a density of the high-density layer, and where each of the high-density layer and the low-density layer includes an adhesive polymer resin.

In an embodiment, the adhesive polymer resin is any one selected from the group consisting of acrylic monomers, urethane monomers, olefin monomers, imide monomers, amide monomers, ester monomers, isocyanate monomers, epoxy monomers, or silicone monomers, and monomers may include polymerized polymers.

In an embodiment, the average diameter of the first hollow particles may be greater than about 5 micrometers and less than or equal to about 40 micrometers, and the average diameter of the second hollow particles may be greater than about 40 micrometers and less than or equal to about 120 micrometers.

In an embodiment, the cushion member may further include a buffer layer disposed on at least one of a rear surface of the high-density layer, between the high-density layer and the low-density layer, and a top surface of the low-density layer.

In an embodiment, the buffer layer may include at least one of TPU, PU, rubber, and olefin-based polymer.

In an embodiment, the thickness of the buffer layer may be about 5 micrometers to about 20 micrometers.

By embodiments, the display device including a cushion member that is excellent in absorbing and dispersing external shock and has excellent resilience may be provided. Accordingly, the durability of the display device may be improved. Additionally, the thin display device may be provided.

### BRIEF DESCRIPTION OF THE DRAWINGS

The above and other embodiments, advantages and features of this disclosure will become more apparent by describing in further detail embodiments thereof with reference to the accompanying drawings, in which:

FIG. 1 is a perspective view of an embodiment of a display device.

FIG. 2 is a cross-sectional view taken along line I-I′ of FIG. 1.

FIG. 3 is a cross-sectional view of the cushion member of FIG. 2.

FIG. 4 is a cross-sectional view of an embodiment of a hollow particle.

FIG. 5 is a schematic diagram of an embodiment of a method for manufacturing a cushion member.

FIG. 6 is an SEM image of an embodiment of a cushion member.

FIG. 7 to FIG. 14 are cross-sectional views of another embodiment of a cushion member.

FIG. 15 is a schematic diagram of an impact absorption evaluation.

FIG. 16 is an image of an embodiment of a cushion member.

FIG. 17 is a block diagram illustrating an embodiment of an electronic device.

FIG. 18 is a view illustrating an embodiment of the electronic device of FIG. 17 implemented as a smartphone.

### DETAILED DESCRIPTION

Hereinafter, with reference to the attached drawings, various embodiments of the disclosure will be described in detail so that those skilled in the art could easily implement the disclosure. The disclosure may be implemented in many different forms and is not limited to the embodiments described herein.

In order to clearly explain the disclosure, parts that are not relevant to the description are omitted, and identical or similar components are assigned the same reference numerals throughout the specification.

In addition, the size and thickness of each component shown in the drawings are arbitrarily shown for convenience of explanation, so the disclosure is not necessarily limited to that which is shown. In the drawings, the thickness is enlarged to clearly express various layers and regions. And in the drawings, for convenience of explanation, the thicknesses of some layers and regions are exaggerated.

Additionally, when a part of a layer, membrane, region, or plate is said to be “above” or “on” another part, this includes not only cases where it is “directly above” another part, but also cases where there is another part in between. In contrast, when an element is referred to as being “directly on” another element, there are no intervening elements present. In addition, being “above” or “on” a reference part means being disposed above or below the reference part, and does not necessarily mean being disposed “above” or “on” it in the direction opposite to gravity.

In addition, throughout the specification, when a part is said to “include” a certain component, this means that it may further include other components rather than excluding other components, unless specifically stated to the contrary.

In addition, throughout the specification, when reference is made to “in a plan view,” this means when the target portion is viewed from above, and when reference is made to “in cross-section,” this means when a cross-section of the target portion is cut vertically and viewed from the side.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). The term “about” can mean within one or more standard deviations, or within +30%, 20%, 10%, 5% of the stated value, for example.

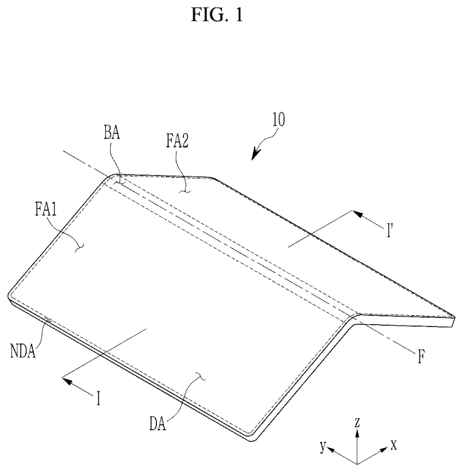

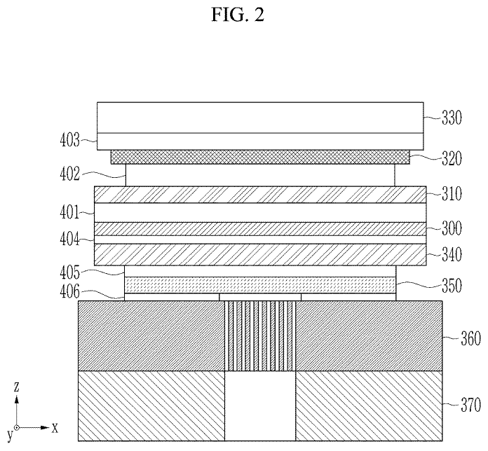

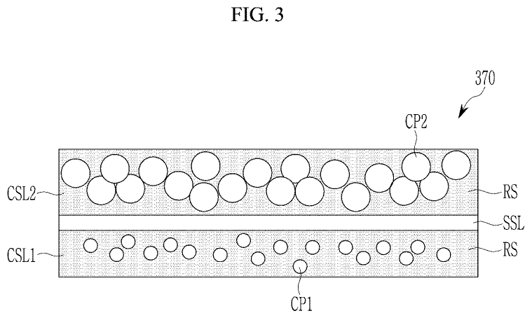

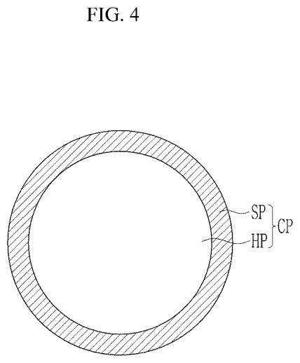

Hereinafter, a display device in an embodiment will be described with reference to FIGS. 1 to 4. FIG. 1 is a perspective view of an embodiment of a display device, FIG. 2 is a cross-sectional view taken along line I-I′ of FIG. 1, FIG. 3 is a cross-sectional view of the cushion member of FIG. 2, and FIG. 4 is a cross-sectional view of an embodiment of a hollow particle.

Referring first to FIG. 1, the first direction x is a direction parallel to one side of the display device 10 in a plan view, and may be the horizontal direction of the display device 10, for example. The second direction y is a direction parallel to an opposite side that contacts one side of the display device 10 in a plan view, and may be the vertical direction of the display device 10. The third direction z may be the thickness direction of the display device 10.

The display device 10 includes a display area DA where an image is displayed and a non-display area NDA excluding the display area. The display area DA may be an area that displays an image including a plurality of pixels. The non-display area NDA is an area that does not include pixels and may be placed around the display area DA.

The display device 10 may be spread out flat as a whole. The display device 10 includes a first flat area FA1, a second flat area FA2, and a foldable area BA. The foldable area BA is an area that folds when folding based on the folding axis F, and the first flat area FA1 and the second flat area FA2 are areas that do not fold. The foldable area BA may be folded around an axis parallel to the second direction y.

Although FIG. 1 shows one foldable area BA, the display device 10 in an embodiment may include one or more foldable areas BA. One or more foldable areas BA may be folded around different axes, e.g., an axis parallel to the first direction x and/or an axis parallel to the second direction y, and the location and width of the foldable area BA of the display device 10 may be changed in various ways.

The display device 10 may maintain both a folded state and an unfolded state. The display device 10 may be folded using an in-folding method in which the display area DA is disposed on the inside, or an out-folding method in which the display area DA is disposed on the outside. When the display device 10 is folded in an out-folding manner, the rear surfaces of the display device 10 may face each other.

When the display device 10 is folded using an out-folding method, there is a high possibility that the display area DA will be exposed to external shocks, be pressed by foreign objects, or being dropped. Therefore, the display device 10 in an embodiment may have enhanced impact resistance characteristics.

Referring to FIG. 2, the display device 10 in an embodiment may include a window protection film 330, a window 320, a first protective layer 310, a display panel 300, a second protective layer 340, a barrier film 350, a support member 360, and a cushion member 370.

Each component constituting the display device 10 may be attached by adhesive members 401, 402, 403, 404, 405, and 406. The adhesive members 401, 402, 403, 404, 405, and 406 may be pressure-sensitive adhesive (“PSA”). The adhesive members 401, 402, 403, 404, 405, and 406 may be a transparent adhesive film (optically clear adhesive (“OCA”) film) or a transparent adhesive resin (optically clear resin (“OCR”)). Each of the adhesive members 401, 402, 403, 404, 405, and 406 may be the same or different.

The display panel 300 may be any one of a light emitting display panel, a liquid crystal display panel, a plasma display panel, an electrophoretic display panel, a microelectromechanical system display panel, or an electrowetting display panel, but is not limited to these.

The first protective layer 310 is disposed on the display panel 300 and may protect the display panel 300. Depending on the embodiment, the first protective layer 310 may function to prevent external light reflection by preventing light from being reflected from inside the display panel 300 and exiting. Although not shown in this specification, depending on the embodiment, the first protective layer 310 may be disposed between the window 320 and the window protection film 330, which will be described later. The first protective layer 310 may include polyethylene terephthalate resin (“PET”), for example.

The window 320 is disposed on the front surface of the first protective layer 310 and serves to protect the display panel 300. The window 320 may be attached to the front surface of the first protective layer 310 by the second adhesive member 402. The window 320 includes or consists of a transparent material and may include glass or plastic, for example. In an embodiment, the window 320 may include ultra-thin glass (“UTG”) with a thickness of 0.1 millimeter (mm) or less, transparent polyimide, PET, polycarbonate (“PC”), etc., for example.

The window protection film 330 may be disposed on the front surface of window 320. The window protection film 330 may be attached to the front surface of the window 320 using the third adhesive member 403. The window protection film 330 may perform at least one of the functions of preventing the window 320 from scattering, absorbing shock, preventing scratches, preventing fingerprints, and preventing glare.

The second protective layer 340 may be disposed on the rear surface of the display panel 300. The second protective layer 340 may be attached to the rear surface of the display panel 300 using the fourth adhesive member 404. The second protective layer 340 may support the display panel 300 and protect the rear surface of the display panel 300.

The barrier film 350 may be disposed on the rear surface of the second protective layer 340. The barrier film 350 may be attached to the rear surface of the second protective layer 340 by the fifth adhesive member 405. The barrier film 350 may prevent moisture and oxygen from penetrating from the outside. Depending on the embodiment, the barrier film 350 may be omitted.

A support member 360 may be disposed on the rear surface of the barrier film 350 to increase the strength and rigidity of the display device 10. The support member 360 may be attached to the rear surface of the barrier film 350 by the sixth adhesive member 406. The sixth adhesive member 406 may not be disposed in the foldable area BA to reduce folding stress when the display device 10 is folded. The sixth adhesive member 406 may be a PSA.

The support member 360 may include at least one reinforcing fiber composite material, depending on the embodiment. In an embodiment, the support member 360 may include at least one of carbon fiber-reinforced plastic (“CFRP”) and glass fiber-reinforced plastic (“GFRP”), for example. In an alternative embodiment, depending on the embodiment, the support member 360 may include metal such as stainless steel (“SUS”), aluminum (Al), magnesium (Mg), or titanium (Ti).

This specification illustrates an embodiment in which the support member 360 is disposed between a cushion member 370 and the barrier film 350, but it is not limited to this, and depending on the embodiment, the support member 360 may also be placed on the lower surface of the cushion member 370.

The cushion member 370 may be disposed below the support member 360. In an embodiment, an adhesive layer may not be disposed between the cushion member 370 and the support member 360. One side of the cushion member 370 facing the support member 360 may include an adhesive function. The cushion member 370 may be disposed on the back of the support member 360. Refer to FIG. 3 for a more detailed look at the cushion member 370.

The cushion member 370 may include a high-density layer CSL1, a buffer layer SSL, and a low-density layer CSL2. In an embodiment, the buffer layer SSL may be disposed on the upper side of the high-density layer CSL1, and the low-density layer CSL2 may be disposed on the upper side of the buffer layer SSL. The low-density layer CSL2 may be attached to the support member 360. It may be attached to the back of the support member 360 of the low-density layer CSL2.

When an impact is applied on the upper side of the low-density layer CSL2, the low-density layer CSL2 may absorb the impact, the buffer layer SSL may disperse the impact, and the high-density layer CSL1 may play a restoration role. However, it is not limited to this, and the cushion member 370 may be custom made into a structure that provides desired physical properties depending on the direction, intensity, area, etc. of impact.

The high-density layer CSL1 in an embodiment may include adhesive polymer resins RS and first hollow particles CP1. The low-density layer CSL2 may include the adhesive polymer resin RS and second hollow particles CP2.

The adhesive polymer resins RS included in each of the high-density layer CSL1 and low-density layer CSL2 may include a polymer composed of any one of monomer selected from a group consisting of acrylic monomers, urethane monomers, olefin monomers, imide monomers, amide monomers, ester monomers, isocyanate monomers, epoxy monomers, or silicone monomers.

The adhesive polymer resin RS may be a copolymer in which a first monomer and a second monomer are copolymerized. The first monomer and the second monomer are different from each other, and each may be one selected from the above-mentioned monomer group.

However, the embodiment is not limited to this, and the second monomer may be a monomer other than the monomer selected from the monomer group described above. In an embodiment, the second monomer may be a diamine-based monomer or a diol-based monomer. Diamine-based monomers or diol-based monomers may be used as crosslinking agents, for example.

In an embodiment, the adhesive polymer resin RS may have a glass transition temperature Tg of −70 degrees Celsius (° C.) to 0° C., for example. In another embodiment, the glass transition temperature Tg of the adhesive polymer resin RS may be −60° C. or higher or −50° C. or higher. Additionally, in another embodiment, the glass transition temperature Tg of the adhesive polymer resin RS may be −10° C. or lower or −20° C. or lower.

The adhesive polymer resin RS may preferably be a copolymer in which a monomer with a high glass transition temperature Tg and a monomer with a low glass transition temperature Tg are copolymerized. As a result, the adhesive polymer resin RS may be given flexibility.

The adhesive polymer resin RS may preferably comprise a hydroxy group and/or a carboxyl group. As a result, the bonding of the adhesive polymer resin RS to the hollow particles CP1 and CP2 may be increased.

When an adhesive layer is disposed on the upper or lower surface of the cushion member 370, the stress on each layer may increase as the number of layers increases. Adhesion may be lost and lifting may occur at the edges of each layer constituting the cushion member 370.

The high-density layer CSL1 and low-density layer CSL2 in an embodiment include an adhesive polymeric resin, so they may be bonded to other components without the need for adhesive layers on the top and bottom of the cushioning member 370, thus avoiding the problems described above. Accordingly, durability of the display device including the cushion member 370 is increased, and an adhesive layer is omitted, making it possible to provide a display device with a slim thickness.

Additionally, since adhesive layers are not disposed on the top and bottom of the cushion member 370 in an embodiment, it may be manufactured through a simple manufacturing process, thereby reducing process costs.

Each of the first and second hollow particles CP1 and CP2 in an embodiment may be dispersed in the adhesive polymer resin RS. The first hollow particles CP1 may be dispersed in the adhesive polymer resin RS included in the high-density layer CSL1. The second hollow particles CP2 may be dispersed in the adhesive polymer resin RS included in the low-density layer CSL2. The first and second hollow particles CP1, CP2 may be uniformly or non-uniformly dispersed in the adhesive polymer resin RS to increase the elasticity of the high-density layer CSL1 and the low-density layer CSL2.

Hereinafter, with reference to FIG. 4, the hollow particles CP including the first hollow particles CP1 and the second hollow particles CP2 will be described. Referring to FIG. 4, the hollow particle CP may include a hollow portion HP and a shell portion SP. The shell portion SP may surround the hollow portion HP. Hollow particles CP may have the shape of a sphere. However, the embodiment is not limited to this, and the hollow particle CP may have an elliptical or quasi-spherical shape with a curved surface of a sphere.

The shell SP of the hollow particle CP may include an organic polymer material. In an embodiment, the shell SP of the hollow particle CP may include a polymer material polymerized from at least one of an acrylic monomer and a vinyl chloride monomer, for example. Preferably, the hollow particle CP may be a copolymer of an acrylonitrile-based monomer and an acrylic monomer, or may be a copolymer of a vinylidene chloride-based monomer and an acrylic monomer.

The density of the hollow particles CP may be 0.08 gram per cubic centimeter (g/cm³) or more and 0.40 g/cm³ or less, e.g., 0.12 g/cm³ or more and 0.30 g/cm³ or less. When the density of the hollow particles CP is less than 0.08 g/cm³, they may not be uniformly dispersed in the polymer resin RS. When the density of the hollow particle CP is 0.40 g/cm³ or more, the thickness of the shell portion SP of the hollow particle CP becomes thick, so the elastic force and impact absorption rate of the hollow particle CP may be reduced.

The average diameter of the hollow particles CP may be 5 micrometers (μm) or more and 120 micrometers (μm) or less—for example, it may be 5 micrometers or more and 80 micrometers or less. When the shape of the hollow particle CP is not spherical, the average diameter of the hollow particle CP may mean the average length of line segments that connect two points on the circumference of the hollow particle CP and pass through the center of gravity of the hollow particle CP.

When the average diameter of the hollow particles CP is less than 5 micrometers, the elastic force and impact absorption rate of the hollow particles CP may be reduced. When the average diameter of the hollow particles CP exceeds 120 micrometers, the roughness of the interface between the high-density layer CLS1 and the low-density layer CLS2 described in FIG. 3 increases. Since the interfacial adhesion between the high-density layer CLS1 and the low-density layer CLS2 is reduced, the defect rate of the display device may increase.

The cushion member 370 in an embodiment includes a high-density layer CLS1 and a low-density layer CLS2 comprising hollow particles having an average diameter of 5 micrometers or more and 120 micrometers or less, and has sufficient interfacial adhesion, so external shock applied to the display device may be alleviated.

Referring back to FIG. 3, in an embodiment, the average diameter of the first hollow particles CP1 may be about 5 micrometers or more and about 40 micrometers or less. Additionally, the average diameter of the second hollow particles CP2 may be greater than about 40 micrometers and less than or equal to about 120 micrometers.

When the high-density layer CSL1 and the low-density layer CSL2 comprise the same or a similar number of hollow particles, the size of the first hollow particle CP1 is smaller than the size of the second hollow particle CP2, so that the volume occupied by the hollow particles comprised in the high-density layer CLS1 may be smaller than the volume occupied by the hollow particles comprised in the low-density layer CLS2. That is, the density of the high-density layer CSL1 may be greater than the density of the low-density layer CSL2.

Additionally, in each of the high-density layer CSL1 and the low-density layer CSL2, the weight ratio of the hollow particles CP1 and CP2 to the total weight may be 0.5 wt % or more and 30.0 wt % or less. The weight ratio of the adhesive polymer resin RS to the total weight of each of the high-density layer CSL1 and the low-density layer CSL2 may be 80.0 wt % or more and 99.5 wt % or less. In an embodiment, the weight ratio of the hollow particles CP1 and CP2 to the total weight of the high-density layer CSL1 and the low-density layer CSL2 may be 5.0 wt % or more and 10.0 wt % or less, and the weight ratio of the adhesive polymer resin RS to the total weight of the high-density layer CSL1 and the low-density layer CSL2 may be 90.0 wt % or more and 95.0 wt % or less. When the weight ratio of hollow particles CP1 and CP2 is less than 0.5 wt %, the impact absorption rate of the high-density layer CSL1 and low-density layer CSL2 is reduced, the display device may be easily damaged by external impact. When the weight ratio of hollow particles CP1 and CP2 exceeds 30.0 wt %, the high-density layer CSL1 and the low-density layer CSL2 may not have sufficient interfacial adhesion, which may cause the interfaces of the high-density layer CSL1 and the low-density layer CSL2 to lift.

In an embodiment, the density of the high-density layer CSL1 may be higher than the density of the low-density layer CSL2. In this case, the high-density layer CSL1 with a relatively high-density may exhibit excellent restoration performance, and the low-density layer CSL2 with a relatively low-density may exhibit high-impact absorption performance.

In an embodiment, the density of the high-density layer CSL1 may be 0.4 g/cm³ or more, 0.45 g/cm³ or more, 0.5 g/cm³ or more, or 0.55 g/cm³ or more. Additionally, the density of the low-density layer CSL2 may be 0.5 g/cm³ or less, 0.45 g/cm³ or less, 0.4 g/cm³ or less, 0.35 g/cm³ or less, 0.3 g/cm³ or less, or 0.25 g/cm³ or less.

In the embodiment, the density of the high-density layer CSL1 and the low-density layer CSL2 may be controlled by hollow particles CP1 and CP2 with different predetermined gravity or by polymer resin RS with different predetermined gravity. In an alternative embodiment, the high-density layer CSL1 and the low-density layer CSL2 may be controlled by varying the ratio of polymer resin RS and hollow particles CP1 and CP2 in the corresponding layer.

The buffer layer SSL in an embodiment may include an elastic polymer. In an embodiment, the buffer layer SSL may include at least one of thermoplastic polyurethane (“TPU”), polyurethane (“PU”), rubber, and olefin-based polymer, for example. The thickness of the buffer layer SSL may be about 5 micrometers to about 20 micrometers.

The buffer layer SSL may have an elongation of 100% to 1000%. Elongation may be measured by ASTM D 3574.

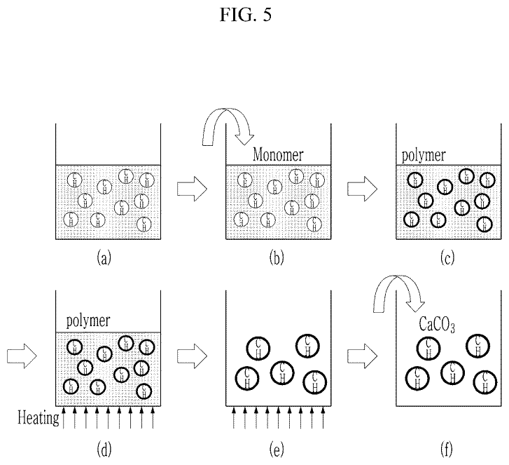

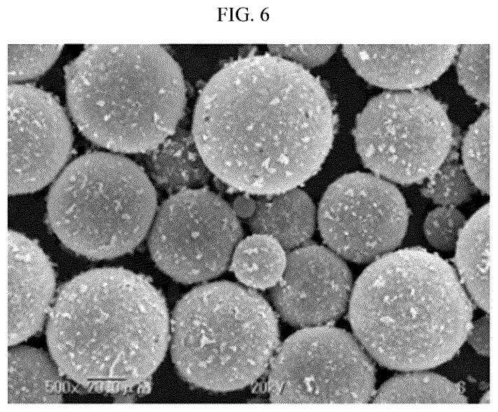

Hereinafter, a method of manufacturing a cushion member in an embodiment will be described with reference to FIGS. 5 and 6. FIG. 5 is a schematic diagram of a method for manufacturing a cushion member in an embodiment, and FIG. 6 is a scanning electron microscopy (“SEM”) image of hollow particles manufactured.

Referring to (a) of FIG. 5, hydrocarbon beads CH are prepared by placing them into a water tank. Then, as shown in (b) of FIG. 5, the monomer is added so that the hydrocarbon beads CH and the monomer undergo a polymerization reaction as shown in (c) of FIG. 5. Afterwards, when heat is provided as shown in (d) of FIG. 5, water as a solvent is removed through a drying process, and the hydrocarbon beads CH are formed into expanded hollow particles as shown in (e) of FIG. 5. Then, as shown in (f) of FIG. 5, hydrocarbon beads CH are coated with calcium carbonate or the like to produce hollow particles as described in FIG. 4. These hollow particles may be represented by images as shown in FIG. 6.

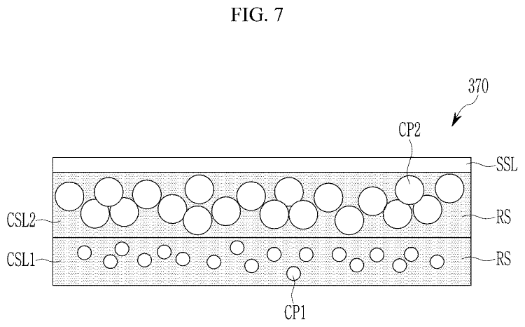

Hereinafter, a cushion member in another embodiment will be described with reference to FIGS. 7 to 14. FIG. 7 to FIG. 14 are cross-sectional views of another embodiment of a cushion member. Descriptions of components that are the same as those of the cushion member described above will be omitted.

First, referring to FIG. 7, the cushion member 370 in an embodiment may include a high-density layer CSL1, a low-density layer CSL2, and a buffer layer SSL. The low-density layer CSL2 in an embodiment may be disposed on the high-density layer CSL1. The buffer layer SSL may be disposed on the low-density layer CSL2. A low-density layer CSL2 may be disposed between the buffer layer SSL and the high-density layer CSL1.

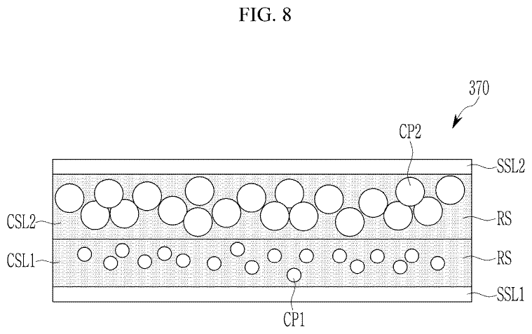

Next, referring to FIG. 8, the cushion member 370 in an embodiment may include a first buffer layer SSL1, a high-density layer CSL1, a low-density layer CSL2, and a second buffer layer SSL2. A high-density layer CSL1 may be disposed on the first buffer layer SSL1, a low-density layer CSL2 may be disposed on the high-density layer CSL1, and a second buffer layer SSL2 may be disposed on the low-density layer CSL2. However, when the buffer layer is disposed at the top of the cushion member, an adhesive layer may be desired for bonding to the support member.

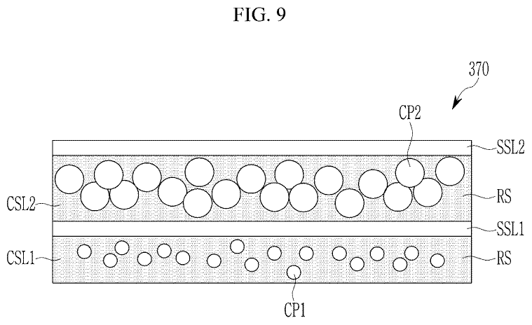

Next, referring to FIG. 9, the cushion member 370 in an embodiment may include a high-density layer CSL1, a first buffer layer SSL1, a low-density layer CSL2, and a second buffer layer SSL2. The first buffer layer SSL1 may be disposed on the high-density layer CSL1, the low-density layer CSL2 may be disposed on the first buffer layer SSL1, and the second buffer layer SSL2 may be disposed on the low-density layer CSL2.

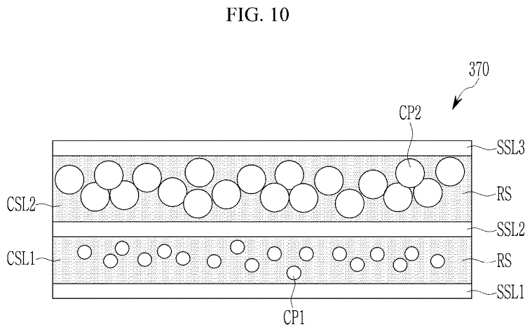

Referring to the following FIG. 10, the cushion member 370 in an embodiment may include a first buffer layer SSL1, a high-density layer CSL1, a second buffer layer SSL2, a low-density layer CSL2, and a third buffer layer SSL3. A high-density layer CSL1 is disposed on the first buffer layer SSL1, a second buffer layer SSL2 is disposed on the high-density layer CSL1, a low-density layer CSL2 is disposed on the second buffer layer SSL2, and a third buffer layer SSL3 may be disposed on the low-density layer CSL2.

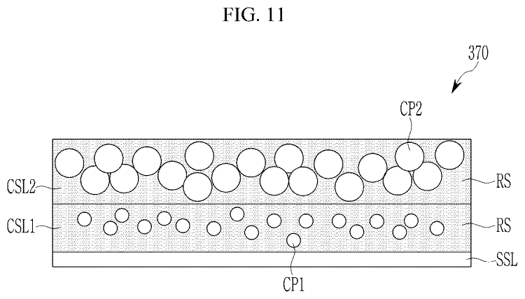

Next, referring to FIG. 11, the cushion member 370 in an embodiment may include a buffer layer SSL, a high-density layer CSL1, and a low-density layer CSL2. A high-density layer CSL1 may be disposed on the buffer layer SSL, and a low-density layer CSL2 may be disposed on the high-density layer CSL1.

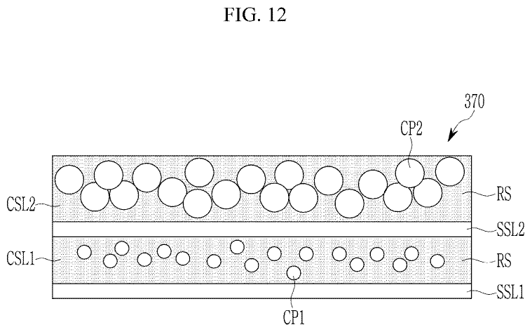

Next, referring to FIG. 12, the cushion member 370 in an embodiment may include a first buffer layer SSL1, a high-density layer CSL1, a second buffer layer SSL2, and a low-density layer CSL2. A high-density layer CSL1 may be disposed on the first buffer layer SSL1, a second buffer layer SSL2 may be disposed on the high-density layer CSL1, and a low-density layer CSL2 may be disposed on the second buffer layer SSL2.

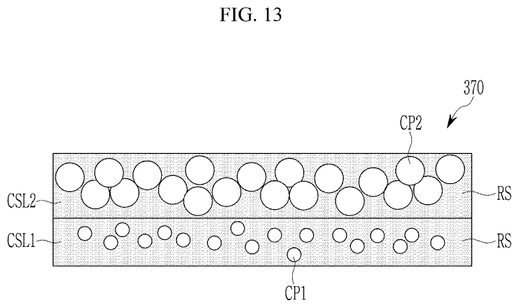

Next, referring to FIG. 13, the cushion member 370 in an embodiment may include a high-density layer CSL1 and a low-density layer CSL2. The low-density layer CSL2 may be disposed on the high-density layer CSL1 and may not include a buffer layer.

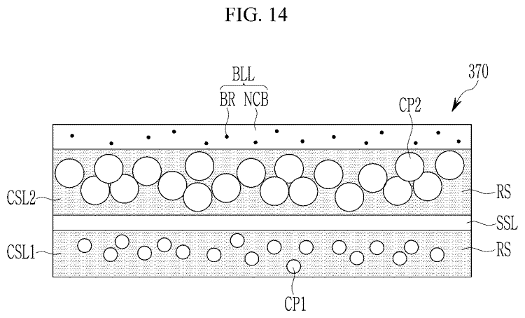

Next, referring to FIG. 14, the cushion member 370 in an embodiment may include a high-density layer CSL1, a buffer layer SSL, a low-density layer CSL2, and a light blocking layer BLL sequentially stacked.

The light blocking layer BLL may include base resin BR and carbon black nanoparticles NCB. The material of the base resin BR is not particularly limited, and materials known in the art, such as polymer resin, may be used without limitation. Carbon black nanoparticles NCB are measured by nanometer units and may comprise carbon elements in the form of colloidal particles produced by incomplete combustion of hydrocarbons. Carbon black nanoparticles have an average diameter of 1 nm to 1000 nm and may absorb light in the visible light range.

Since the cushion member 370 includes the light blocking layer BLL, light incident from the outside of the display device is absorbed by the light blocking layer BLL, thereby reducing external light reflection. Accordingly, visibility of the display device may be improved.

This specification illustrates an embodiment in which the light blocking layer BLL is disposed on the low-density layer CSL2, but the light blocking layer BLL is not limited to this and may be placed at any position included in the cushion member 370.

Hereinafter, the characteristics of the cushion member in an embodiment will be examined in detail.

### 1. Evaluation of Impact Absorption Performance According to the Elastomer of the Buffer Layer

(1) Production of Cushion Members

A cushion member with a total thickness of 300 micrometers was manufactured with a buffer layer disposed on the upper side of the high-density layer. The high-density layer was a rigid adhesive polymeric resin comprising polymerized acrylic-based monomers and is prepared by including hollow particles having an average diameter of 20 micrometers or more and 40 micrometers or less. The buffer layer was manufactured using different elastic polymers as shown in Table 1 below. Comparative Example 1 is a cushion member consisting of only a high-density layer without a buffer layer. In Embodiments 1 to 3, the thickness of the buffer layer was 5 micrometers.

TABLE 1

| | Embodiment | Embodiment | Embodiment | Comparative |
|---|---|---|---|---|
| | 1 | 2 | 3 | Example 1 |
| Elastomer | Olefin | PET | TPU | — |
| Elongation (%) | 300 | 50-150 | 500 | — |

(2) Density measurement; the densities of the cushion members of Embodiments 1 to 3 of Table 1 and Comparative example 1 were measured and shown in Table 2 below. Specifically, the density of each cushion member was calculated by measuring the weight and volume using an electronic scale, thickness gauge, and ruler.

TABLE 2

| | Embodiment | Embodiment | Embodiment | Comparative |
|---|---|---|---|---|
| | 1 | 2 | 3 | Example 1 |
| Density | 0.78 | 0.81 | 0.78 | 0.70 |
| (g/cm³) | | | | |

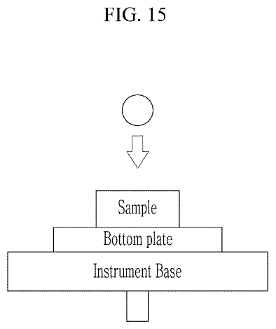

(3) Impact absorption performance evaluation; a pressure-sensitive paper evaluation was performed on the cushion members of Embodiments 1 to 3 and Comparative Example 1. For the pressure-sensitive paper evaluation, a cushioning member specimen was attached to a fabric with a width of 30 mm each, and a ball drop test was performed by attaching the cushioning member specimen to the pressure-sensitive paper, pressing the fabric onto the pressure-sensitive paper with a roller, and storing the sample for 1 day to remove air bubbles. As shown in FIG. 15, a steel ball weighing 112 gram (g) was dropped from a height of 15 centimeter (cm) with the sample on the bottom plate, and the pressure-sensitive paper was scanned with the reader (instrument base) to measure the maximum pressure. The results are shown in Table 3 below. As the measured maximum pressure becomes greater, the amount of impact becomes greater and the impact absorption performance becomes lower. Here, an impact amount was measured in terms of megapascal (Mpa).

TABLE 3

| | Embodiment | Embodiment | Embodiment | Comparative |
|---|---|---|---|---|
| | 1 | 2 | 3 | Example 1 |
| Impact | 42.2 | 43.4 | 40.1 | 45.4 |
| amount | | | | |
| (Mpa) | | | | |

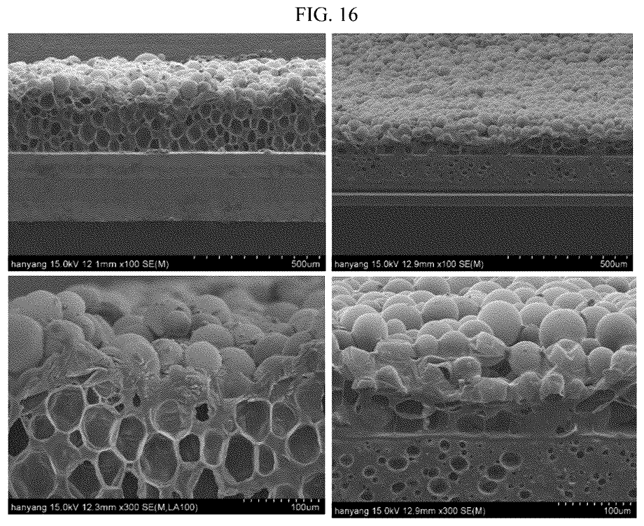

As shown in Table 3, it was confirmed that the impact absorption performance of Embodiments 1 to 3 manufactured including a buffer layer was superior to that of Comparative Example 1 manufactured with only a high-density layer (corresponding to the two left images of FIG. 16). In particular, it was confirmed that Embodiment 3, in which the buffer layer includes TPU material, had the best impact absorption performance.

### 2. Evaluation of Impact Absorption Performance According to the Structure of the Cushion Member

(1) Production of Cushion Members

A cushion member having the laminated structure shown in Table 4 below was manufactured. While maintaining the thickness of the cushion member uniformly at 300 micrometers, the thicknesses of the high-density layer (and low-density layer) and buffer layer were adjusted, and in the laminated structure of Embodiments 3 to 5, the thickness of each buffer layer is 5 micrometers, in Embodiment 4 the thickness of each high-density layer and low-density layer is 145 micrometers, and in Embodiment 5 the thickness of each high-density layer and low-density layer is 147.5 micrometers.

TABLE 4

| | Embodiment | Embodiment | Embodiment | Comparative |
|---|---|---|---|---|
| | 3 | 4 | 5 | Example 1 |
| Stacking | buffer | buffer | low- | high- |
| structure | layer (TPU)/ | layer (TPU)/ | density layer/ | density layer |
| | high- | low- | buffer | (single |
| | density layer | density layer/ | layer (TPU)/ | layer) |
| | | buffer | high- | |
| | | layer (TPU)/ | density layer | |
| | | high- | | |
| | | density layer | | |

Specifically, Embodiment 3 is a structure where a buffer layer is placed on top of the high-density layer, and Embodiment 4 is a structure where a first buffer layer is placed on top of the high-density layer, a low-density layer is placed on top of the first buffer layer, and a second buffer layer is placed on top of the low-density layer. Embodiment 5 has a structure in which a buffer layer is disposed on the upper side of the high-density layer and a low-density layer is disposed on the upper side of the buffer layer, and the comparative example was manufactured with only the high-density layer. Embodiments 3 to 5 include high-density layers and low-density layers that consist of hard adhesive polymer resins with polymerized acrylic monomers and were manufactured to include hollow particles with an average diameter of at least 20 micrometers but not exceeding 40 micrometers, and the buffer layer was manufactured with TPU material, as in Embodiment 3. (2) Density measurement and impact absorption performance evaluation.

The results of density measurement and pressure-sensitive paper evaluation of the cushion members of Embodiments 3 to 5 and Comparative Example 1 are shown in Table 5 below.

TABLE 5

| | Embodiment | Embodiment | Embodiment | Comparative |
|---|---|---|---|---|
| | 3 | 4 | 5 | Example 1 |
| Density | 0.78 | 0.81 | 0.78 | 0.70 |
| (g/cm³) | | | | |
| Impact | 40.1 | 40.0 | 38.7 | 45.4 |
| amount | | | | |
| (Mpa) | | | | |

As shown in Table 5, the impact absorption performance of Embodiments 3 to 5, which were made including a buffer layer, is superior to Comparative Example 1, which was made only with a high-density layer. In particular, it may be seen that example 5, which has a structure with a buffer layer placed between the high-density and low-density layers (corresponding to the two rightmost images in FIG. 16), has the best impact absorption performance.

### 3. Evaluation of Impact Absorption Performance According to the Polymer Resin Material of the High-Density Layer and Low-Density Layer

(1) Production of Cushion Members

A cushion member with a thickness of 300 micrometers was manufactured with a high-density layer comprising the polymer resin shown in Table 6 below. In this experiment, the cushion component was consisting of a single high-density layer without a buffer layer.

TABLE 6

| | Embodiment | Embodiment | Embodiment | Comparative |
|---|---|---|---|---|
| | 6 | 7 | 8 | Example 2 |
| Glass | −60 | −40 | −30 | −20 |
| transition | | | | |
| temperature | | | | |
| (Tg)(° C.) | | | | |
| Functional | hydroxy | carboxyl | carboxyl group | hydroxy group |
| group | group(—OH) | group(—COOH) | (—COOH) | (—OH) and |
| | | | | carboxyl group |
| | | | | (—COOH) |
| Hardener | Isocyanate | epoxy | epoxy | isocyanate |
| Solvent | ethyl acetate | EA/Tol | EA/Tol | EA/Tol/ |
| | (“EA”)/ | | | Kapton ® |
| | toluene | | | |
| | (“Tol”)/ | | | |
| | Kapton ® | | | |

(2) Impact absorption performance evaluation; the results of the pressure-sensitive paper evaluation of the cushion members of Embodiments 6 to 8 and Comparative Example 2 are shown in Table 7 below.

TABLE 7

| | Embodiment | Embodiment | Embodiment | Comparative |
|---|---|---|---|---|
| | 6 | 7 | 8 | Example 2 |
| Impact | 41.8 | 43.5 | 44.1 | 45.4 |
| amount | | | | |
| (Mpa) | | | | |

As shown in Table 7, it was confirmed that as the glass transition temperature of the polymer resin contained in the high-density layer becomes lower, the flexibility becomes greater, and the impact absorption performance becomes better.

### 4. Evaluation of Impact Absorption Performance According to Hollow

Particle Content of High-Density Layer
(1) Production of Cushion Members

A cushion member with a thickness of 300 micrometers was manufactured with the same laminated structure as in Embodiment 5 in which a buffer layer was disposed between the high-density layer and the low-density layer. The high-density layer contained the same polymer resin as Embodiment 6, and was manufactured by including different amounts of hollow particles according to the contents in Table 8 below. The buffer layer includes TPU material in the same manner as in Embodiment 3.

TABLE 8

| | Embodiment | Embodiment | Embodiment | Embodiment | Embodiment |
|---|---|---|---|---|---|
| | 9 | 10 | 11 | 12 | 13 |
| Hollow | 2 | 4 | 7 | 10 | 20 |
| particle | | | | | |
| (wt %) | | | | | |

(2) Density measurement and impact absorption performance; evaluation the results of density measurement and pressure-sensitive paper evaluation for the cushion members of Embodiments 9 to 13 are shown in Table 9 below.

TABLE 9

| | Embodiment | Embodiment | Embodiment | Embodiment | Embodiment |
|---|---|---|---|---|---|
| | 9 | 10 | 11 | 12 | 13 |
| density | 0.79 | 0.66 | 0.60 | 0.50 | 0.23 |
| (g/cm³) | | | | | |
| Impact | 40.5 | 39.1 | 37.9 | 38.5 | 39.8 |
| amount | | | | | |
| (Mpa) | | | | | |

As shown in Table 9, it was confirmed that the impact absorption performance of the cushion members including the impact absorption layer in which the weight ratio of hollow particles to the total weight of the high-density layer was 2 to 20 wt % was excellent. In particular, as in Embodiment 11, it was confirmed that the impact absorption performance of the cushion member was the best when the weight ratio of hollow particles to the total weight of the high-density layer was 7 wt %.

### 5. Evaluation of Impact Absorption Performance According to the Thickness of the Buffer Layer

(1) Production of Cushion Members

A cushion member with a thickness of 300 micrometers was manufactured in which a buffer layer was disposed between a high-density layer and a low-density layer of the same thickness, and the thickness of the buffer layer in each member is shown in Table 10 below. Each of the high-density layer and the low-density layer contained the same polymer resin as Embodiment 6, and were prepared by including 7 wt % of hollow particles based on the total weight of each layer. The buffer layer includes the same TPU material as in Embodiment 3, and was manufactured with different thicknesses according to the thicknesses in Table 10 below.

TABLE 10

| | Embodiment | Embodiment | Embodiment | Embodiment | Embodiment |
|---|---|---|---|---|---|
| | 14 | 15 | 16 | 17 | 18 |
| Thickness | 5 | 7 | 10 | 15 | 20 |
| (μm) | | | | | |
| Thickness | 1.67 | 2.33 | 3.33 | 5.00 | 6.67 |
| ratio (%) | | | | | |

(2) Impact absorption evaluation; the results of the pressure-sensitive evaluation of the cushion members of Embodiments 14 to 18 are shown in Table 11 below.

TABLE 11

| | Embodiment | Embodiment | Embodiment | Embodiment | Embodiment |
|---|---|---|---|---|---|
| | 14 | 15 | 16 | 17 | 18 |
| Impact | 38.1 | 37.9 | 37.3 | 37.3 | 37.4 |
| amount | | | | | |
| (Mpa) | | | | | |

As shown in Table 11, it was confirmed that the impact absorption performance of cushion members with a buffer layer thickness of 5 to 20 micrometers was all excellent. In addition, when the thickness of the buffer layer was 10 micrometers or less, the impact absorption performance improved as the thickness increased, but when the thickness of the buffer layer was 10 micrometers or more, it was confirmed that the impact absorption performance was at a similar level even as the thickness increased.

### 6. Evaluation of Impact Absorption Performance According to the Density of High-Density Layer and Low-Density Layer

(1) Production of Cushion Members

A cushion member with a thickness of 300 micrometers was manufactured with the same laminated structure as in Embodiment 5 in which a buffer layer was disposed between the high-density layer and the low-density layer. Cushion members with the same or different densities of the high-density layer and the low-density layer were manufactured according to the densities in Table 12 below.

TABLE 12

| | Embodiment | Embodiment | Embodiment | Embodiment |
|---|---|---|---|---|
| | 19 | 20 | 21 | 22 |
| Low-density layer | 0.60 | 0.23 | 0.60 | 0.23 |
| density (g/cm³) | | | | |
| High-density layer | 0.60 | 0.23 | 0.23 | 0.60 |
| density (g/cm³) | | | | |

(2) Impact absorption performance evaluation; the results of the pressure-sensitive paper evaluation of the cushion members of Embodiments 19 to 22 are shown in Table 13 below.

TABLE 13

| | Embodiment | Embodiment | Embodiment | Embodiment |
|---|---|---|---|---|
| | 19 | 20 | 21 | 22 |
| Impact | 37.9 | 39.8 | 37.8 | 37.0 |
| amount | | | | |
| (Mpa) | | | | |

As shown in Table 13, it was confirmed that the impact absorption performance is the best when the density of the high-density layer beneath the buffer layer is higher than the density of the low-density layer above the buffer layer.

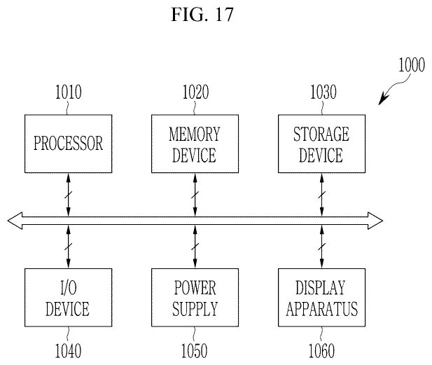

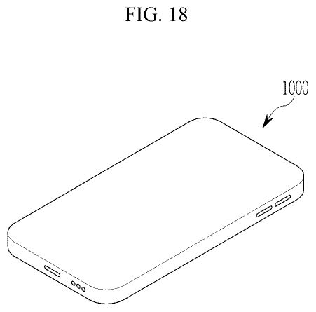

FIG. 17 is a block diagram illustrating an embodiment of an electronic device. FIG. 18 is a view illustrating an embodiment of the electronic device of FIG. 17 implemented as a smartphone.

Referring to FIGS. 17 and 18, in an embodiment, an electronic device 1000 may include a processor 1010, a memory device 1020, a storage device 1030, an input/output (“I/O”) device 1040, a power supply 1050, and a display device 1060. Here, the display device 1060 may correspond to the display device 10 of FIG. 1. The electronic device 1000 may further include a plurality of ports for communicating with a video card, a sound card, a memory card, a universal serial bus (“USB”) device, or the like. In an embodiment, the electronic device 1000 may be implemented as a television. In another embodiment, the electronic device 1000 may be implemented as a smart phone. However, embodiments are not limited thereto, in another embodiment, the electronic device 1000 may be implemented as a cellular phone, a video phone, a smart pad, a smart watch, a tablet personal computer, a car navigation system, a computer monitor, a laptop, a head disposed (e.g., mounted) display (“HMD”), or the like.

The processor 1010 may perform various computing functions. In an embodiment, the processor 1010 may be a microprocessor, a central processing unit (“CPU”), an application processor (“AP”), or the like. The processor 1010 may be coupled to other components via an address bus, a control bus, a data bus, or the like. In an embodiment, the processor 1010 may be coupled to an extended bus such as a peripheral component interconnection (“PCI”) bus.

The memory device 1020 may store data for operations of the electronic device 1000. In an embodiment, the memory device 1020 may include at least one non-volatile memory device such as an erasable programmable read-only memory (“EPROM”) device, an electrically erasable programmable read-only memory (“EEPROM”) device, a flash memory device, a phase change random access memory (“PRAM”) device, a resistance random access memory (“RRAM”) device, a nano floating gate memory (“NFGM”) device, a polymer random access memory (“PoRAM”) device, a magnetic random access memory (“MRAM”) device, a ferroelectric random access memory (“FRAM”) device, or the like, and/or at least one volatile memory device such as a dynamic random access memory (“DRAM”) device, a static random access memory (“SRAM”) device, a mobile DRAM device, or the like.

In an embodiment, the storage device 1030 may include a solid state drive (“SSD”) device, a hard disk drive (“HDD”) device, a CD-ROM device, or the like. In an embodiment, the I/O device 1040 may include an input device such as a keyboard, a keypad, a mouse device, a touchpad, a touch-screen, or the like, and an output device such as a printer, a speaker, or the like.

The power supply 1050 may provide power for operations of the electronic device 1000. The power supply 1050 may provide power to the display device 1060. The display device 1060 may be coupled to other components via the buses or other communication links. In an embodiment, the display device 1060 may be included in the I/O device 1040.

In an embodiment the electronic device may be implemented as a smartphone. However the embodiments of the present disclosure may be exemplary and may not be limited to this. For example, the electronic device 1000 may be implemented as a mobile phone, a video phone, a smart pad, a smart watch, a television, a tablet personal computer, a vehicle display, a computer monitor, a notebook computer, a head-mounted display device, etc. In addition, the electronic device 1000 may be a television, a monitor, a notebook computer, or a tablet. In addition, the electronic device 1000 may be a car.

Although the embodiments of the disclosure have been described in detail above, the scope of the disclosure is not limited thereto, and various modifications and improvements made by those skilled in the art using the basic concepts of the disclosure defined in the following claims are also possible.

What is claimed is:

1. A display device comprising:
a display panel;
a window disposed on a side of the display panel; and
a cushion member disposed on a rear surface of the display panel, the cushion member comprising:
a high-density layer;
a buffer layer disposed on the high-density layer; and
a low-density layer disposed on the buffer layer,
wherein the low-density layer is disposed closer to the display panel than to the high-density layer.

2. The display device of claim 1, wherein:
the high-density layer includes first hollow particles,
the low-density layer includes second hollow particles, and
a hollow volume of the high-density layer is smaller than a hollow volume of the low-density layer.

3. The display device of claim 2, wherein:
a size of a first hollow particle of the first hollow particles is smaller than a size of a second hollow particle of the second hollow particles.

4. The display device of claim 2, wherein:
the first hollow particles and the second hollow particles have an average diameter of about 5 micrometers or more and about 120 micrometers or less.

5. The display device of claim 2, wherein:
a weight ratio of the first hollow particles to a total weight in the high-density layer is 0.5 wt % or more and 30 wt % or less.

6. The display device of claim 1, wherein:
a density of the high-density layer is about 0.4 gram per cubic centimeter or more,
a density of the low-density layer is 0.5 gram per cubic centimeter or less, and
the density of the low-density layer is lower than the density of the high-density layer.

7. The display device of claim 1, wherein:
each of the high-density layer and the low-density layer includes an adhesive polymer resin.

8. The display device of claim 7, wherein:
the adhesive polymer resin has a glass transition temperature of −70 degrees Celsius to 0 degrees Celsius.

9. The display device of claim 1, wherein:
the buffer layer comprises at least one of thermoplastic polyurethane, polyurethane, rubber, and olefin polymer.

10. The display device of claim 1, wherein:
the cushion member further includes:
an additional buffer layer disposed on at least one of an upper surface of the low-density layer and a lower surface of the high-density layer.

11. The display device of claim 1, wherein:
the display device is folded out.

12. The display device of claim 1, further comprising: a protective layer disposed on the display panel.

13. The display device of claim 1, further comprising a support member disposed on the rear surface of the display panel.

14. The display device of claim 13, wherein:
the support member comprises at least one of carbon fiber-reinforced plastic carbon fiber-reinforced plastic, glass fiber-reinforced plastic glass fiber-reinforced plastic, stainless steel, aluminum (Al), magnesium (Mg), and titanium (Ti).

15. An electronic device comprising:
a display device comprising:
a display panel;
a window disposed on a side of the display panel; and
a cushion member disposed on a rear surface of the display panel, the cushion member comprising:
a high-density layer;
a buffer layer disposed on the high-density layer; and
a low-density layer disposed on the buffer layer,
wherein the low-density layer is disposed closer to the display panel than to the high-density layer.

16. The electronic device of claim 15, wherein:
the high-density layer includes first hollow particles,
the low-density layer includes second hollow particles, and
a hollow volume of the high-density layer is smaller than a hollow volume of the low-density layer.

17. The electronic device of claim 16, wherein:
a size of the first hollow particle of the first hollow particles is smaller than a size of the second hollow particle of the second hollow particles.

18. The electronic device of claim 16, wherein:
the first hollow particles and the second hollow particles have an average diameter of about 5 micrometers or more and about 120 micrometers or less.

19. The electronic device of claim 16, wherein:
a weight ratio of the first hollow particles to a total weight in the high-density layer is 0.5 wt % or more and 30 wt % or less.

20. The electronic device of claim 15, wherein:
a density of the high-density layer is about 0.4 gram per cubic centimeter or more,
a density of the low-density layer is 0.5 gram per cubic centimeter or less, and
the density of the low-density layer is lower than the density of the high-density layer.
